(19) United States
(12) Patent Application Publication
(10) Pub. No.: US 2021/0403031 A1
(43) Pub. Date: Dec. 30, 2021

(54) DISAMBIGUATION OF VEHICLE NAVIGATION ACTIONS

(71) Applicant: Intel Corporation, Santa Clara, CA (US)

(72) Inventors: Ignacio J. ALVAREZ, Portland, OR (US); Javier S. TUREK, Beaverton, OR (US); Maria Soledad ELLI, Hillsboro, OR (US); Javier FELIP LEON, Hillsboro, OR (US); David Israel GONZALEZ AGUIRRE, Portland, OR (US)

(21) Appl. No.: 17/471,199

(22) Filed: Sep. 10, 2021

(51) Int. Cl. B60W 60/00; G06F 40/20; G01C 21/34

(52) U.S. Cl. CPC B60W 60/001; B60W 2556/50; G01C 21/3461; G06F 40/20

(57) ABSTRACT

An autonomous vehicle (AV) system may include a memory having computer-readable instructions stored thereon. The AV system may include a processor operatively coupled to the memory and configured to read and execute the computer-readable instructions to perform or control performance of operations. The operations may include receive an instruction text vector representative of a command for an AV provided by a user. The operations may include receive an environment text vector representative of a spatio-temporal feature of an environment of the AV. The operations may include generate a sense set that includes words based on the instruction text vector and the environment text vector. The operations may include compare the words of the sense set to navigational instructions (NIs) within a corpus and identify a NI that corresponds to the words based on the comparison. The operations may also include update a trajectory of the AV based on the NI.

### FIELD

The aspects discussed in the present disclosure are related to disambiguation of vehicle navigation actions.

### BACKGROUND

Unless otherwise indicated, the materials described in the present disclosure are not prior art to the claims in the present application and are not admitted to be prior art by inclusion in this section.

An autonomous vehicle (AV) navigation system may be configured to cause an AV to follow a navigation route according to navigational instructions (NIs). The NIs may be based on a destination input provided by a user or other entity. The destination input may be received using haptic devices and dialogue managers.

The subject matter claimed in the present disclosure is not limited to aspects that solve any disadvantages or that operate only in environments such as those described above. Rather, this background is only provided to illustrate one example technology area where some aspects described in the present disclosure may be practiced.

### BRIEF DESCRIPTION OF THE DRAWINGS

Exemplary aspects will be described and explained with additional specificity and detail through the use of the accompanying drawings in which:

FIG. 1 illustrates a block diagram of an exemplary operational environment of an AV navigation system;

FIG. 2. illustrates a block diagram of another exemplary operating environment of the AV navigation system;

FIG. 3 illustrates a flowchart of an exemplary method to generate an instruction text vector;

FIG. 4 illustrates a flowchart of a method to extract features from an internal file and generate the internal text vector;

FIG. 5 illustrates a flowchart of a method to extract features from the external file and generate the external text vector;

FIG. 6 illustrates a flowchart of a method to generate a navigational corpus;

FIG. 7 illustrates a flowchart of a method to generate a navigation action diagram based on a known driving dataset;

FIG. 8 illustrates a blocking diagram of the AV navigation system determining the particular NI based on text vectors; and

FIG. 9 illustrates an exemplary weighted graph to generate a sense set,

all according to at least one aspect described in the present disclosure.

### DETAILED DESCRIPTION

The following detailed description refers to the accompanying drawings that show, by way of illustration, exemplary details in which aspects of the present disclosure may be practiced.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

An AV navigation system may be configured to cause an AV to follow a navigation route according to NIs. The NIs may be based on a destination input provided by a user or other entity. The destination input may be provided based on a point of interest (POI) selected by the user. The AV navigation system may identify the POI based on a geographical location (e.g., an address) or a semantic tag linked to an individual position on a map. The destination input may be provided by the user using various devices including a knob selector, a keyboard integrated into the AV navigation system, verbal instructions (e.g., “drive me to Olympia Park in Munich”), an input device integrated into an external computing device, or some combination thereof.

The user may provide a navigation command to the AV navigation system to update the navigation route, the NIs, or some combination thereof (generally referred to in the present disclosure as “navigation plan”) (e.g., change the trajectory of the AV) while the AV is in motion. The navigation command may be provided using a haptic device, a dialogue manager (e.g., a natural language processor (NLP)), or some combination thereof. Examples of the haptic devices may include an actuating blinker signal that indicates or confirms a lane change or a forced feedback device.

The navigation command may include navigational cues (e.g., “stop there,” “take a right turn,” or “park behind that car”), an updated destination, a last-mile navigational cue, or some combination thereof. Examples navigation commands are “pull up to the curb, I don't know maybe in 50 feet?”, “can you go on the next, uh, entrance?”, “can you pull up about 20 feet and around the bus and drop me off?”, “there is right, park to my left or right.”

An external environment (e.g., a surface the AV is operating on, a sidewalk proximate the AV, a road or street the AV is operating, an area proximate the road or street, or any other appropriate external environment of the AV) may dynamically change, which may impact how the user provides the navigation command. Further, extraneous circumstances (e.g., the user being late for an appointment) may also impact how the user provides the navigation command.

The AV navigation system may identify a particular NI that corresponds to the navigation command. For example, the navigation command may include “change lane to the right” and the AV navigation system may identify the particular NI as “initiate lane-change maneuver to immediate right lane if right lane exists and it is safe.” The AV navigation system may update the navigation plan based on the particular NI (e.g., the AV navigation system may cause the trajectory of the AV to change).

The navigation command may include natural language provided by the user. For example, the natural language may be spoken or typed by the user. The navigation command may not include specific instruction constructs (e.g., known keywords) that clearly describe the update that is to be made to the navigation plan. In addition, the navigation command may not include context related to the AV or the user (e.g., features of an external environment or an internal environment of the AV). The lack of specific instructions or context may cause the navigation command to be ambiguous to the AV navigation system. The navigation command may be ambiguous to the AV navigation system due to multiple reasons. For example, the navigation command may include grammatical errors, language subtleties, or other language issues or nuances.

The AV navigation system may map the navigation command to the NIs to identify the particular NI. However, if the navigation command is ambiguous to the AV navigation system, the AV navigation system may incorrectly map the navigation command (e.g., identify an incorrect particular NI).

Some dialogue management technologies may implement intent recognition, conversational loops, or some combination thereof to resolve commands that are ambiguous. An example of a conversational loop may be a command of “what is the count of pollen in . . . , outside, right now?” and response by the dialogue management technology of “I didn't quite get that, can you please repeat? If you want me to look things up in the Internet, just say search for.”

These dialogue management technologies may increase a likelihood of incorrectly identifying an intent of the command or cause a long or endless conversational loop to occur. If these dialogue management technologies are implemented in an AV, the conversational loop may cause a temporal window in which the navigation command is valid to be missed.

Some aspects described in the present disclosure may determine an intent of the user based on the navigation command and features of the external environment, the internal environment, or some combination thereof of the AV.

The AV navigation system may include a disambiguator that operates as a bridge between an in-vehicle dialogue manager (IVI), a route planner, and a driving policy of the AV. The AV navigation system may disambiguate the navigation command by mapping words of the navigation command to the NIs that are interpretable using the route planner, the diving policy, or some combination thereof. The AV navigation system may map words of the navigation command to the NIs of a navigational corpus according to Equation 1.

T[(w1,w2,wn)]→A(i)⊆NavigationD(wi) Equation 1

In Equation 1, (w1, w2, . . . wn) represent words of the navigation command, NavigationD (wi) represents the NIs that the AV is capable of performing in which i represents a positive integer representative of a maximum number of NIs to be included in the calculation, T represents a current context, and A(i) represents a subset of the NIs that match for the current context. Sometimes, the navigation command may correspond to one NI (e.g., |A(i)|=1). However, other times, the navigation command may correspond to multiple NIs (e.g., |A(i)|>1) and the AV navigation system may select the particular NI form the multiple NIs. The integer representative of the maximum number of NIs may be pre-configured or configurable.

The AV navigation system may identify the particular NI using the navigational corpus that includes the NIs (e.g., navigational behaviors), the features of the external environment extracted from an external file (e.g., temporal scene descriptors extracted from the driving policy and mapped to the navigation command), the features of the internal environment extracted from an internal file (e.g., temporal descriptors extracted from the internal file), or some combination thereof. The AV navigation system may identify a closest NI (e.g., the NI that most closely maps to the navigation command, the features of the external environment or the internal environment, or some combination thereof) to update the navigation plan.

The AV navigation system may disambiguate the navigation command even if the navigation command is ambiguous or includes improperly constructed sentences. The AV navigation system may identify the intent of the user by performing word sense and sentence disambiguation.

The AV navigation system may include a memory having computer-readable instructions store thereon. The AV navigation system may also include a processor operatively coupled to the memory. The processor may be configured to read and execute the computer-readable instructions to perform or control performance of operations. The operations may include receive an instruction text vector representative of the navigation command for the AV provided by the user in natural language. The operations may also include receive an environment text vector representative of a spatio-temporal feature of an environment of the AV. In addition, the operations may include generate a sense set that includes words based on the instruction text vector and the environment text vector. Further, the operations may include compare the words of the sense set to the NIs within the navigational corpus. The operations may include identify the particular NI of the NIs that corresponds to the words based on the comparison. The operations may include update the vehicle trajectory of the AV based on the particular NI.

At least one aspect described in the present disclosure may reduce complexity, user frustration, or some combination thereof associated with providing the navigation command in natural language. In addition, at least one aspect described in the present disclosure may increase user trust in the AV navigation system, which may reduce user interreference.

These and other aspects of the present disclosure will be explained with reference to the accompanying figures. It is to be understood that the figures are diagrammatic and schematic representations of such example aspects, and are not limiting, nor are they necessarily drawn to scale. In the figures, features with like numbers indicate like structure and function unless described otherwise.

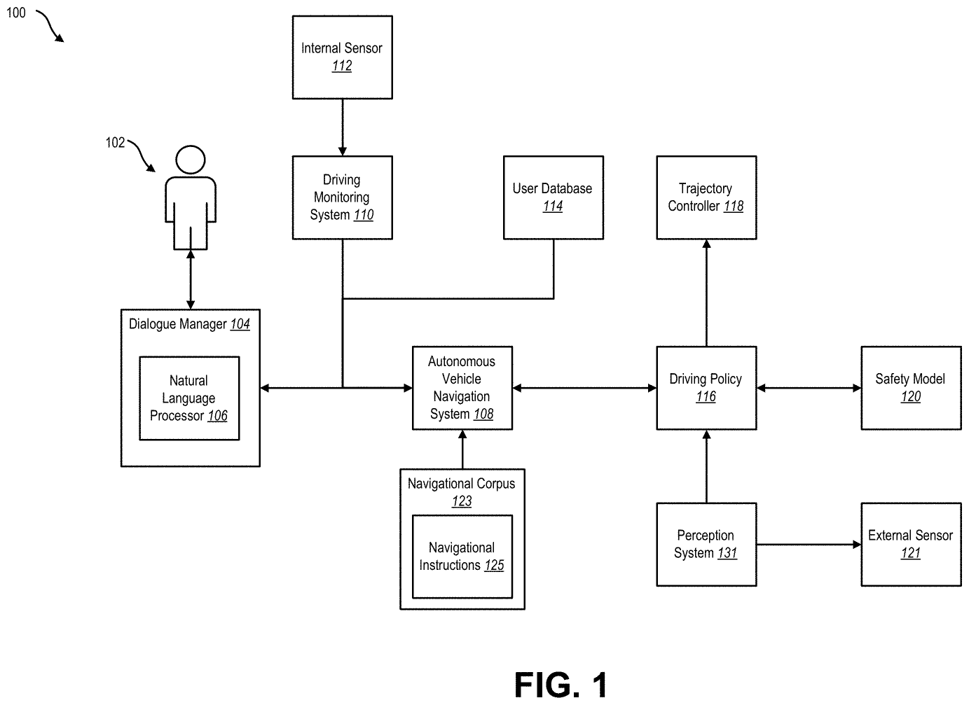

FIG. 1 illustrates a block diagram of an exemplary operational environment 100 of an AV navigation system 108, in accordance with at least one aspect described in the present disclosure. The operational environment 100 may form part of an AV or an environment the AV operates within. The operational environment 100 may include the AV navigation system 108 (e.g., a disambiguator), a dialogue manager 104, a driving monitor system (DMS) 110, a driving policy 116, a safety model 120, a navigational corpus 123, and a trajectory controller 118.

A user 102 may provide the navigation command to the dialogue manager 104. The user 102 may provide the navigation command as a voice command (e.g., an utterance by the user 102) or a gesture via a haptic device. The navigation command may include a change to a navigation plan.

The dialogue manager 104 may generate an instruction file representative of the navigation command. The dialogue manager 104 may include an NLP 106. The NLP 106 may receive the instruction file. The NLP 106 may generate an instruction text vector based on the instruction file. The instruction text vector may describe the navigation command in text form.

The DMS 112 may be communicatively coupled to an internal sensor 112. The internal sensor 112 may monitor an internal environment of the AV. For example, the internal sensor 112 may monitor an internal cabin of the AV. The internal sensor 112 may include multiple sensors. For example, the internal sensor 112 may include a camera, a microphone, or any other appropriate sensor. The internal sensor 112 may generate an internal file that includes a rendered representation of the internal environment of the AV.

The DMS 110 may receive the internal file from the internal sensor 112. The DMS 110 may include a memory (not illustrated in FIG. 1) that stores the internal file. In addition, the DMS 110 may receive a user ID associated with one or more passengers riding in the AV. The DMS 110 may forward the internal file to the AV navigation system 108. The internal text vector may describe spatio-temporal features of the internal environment of the AV in text form.

The AV navigation system 108 may receive the user database 114. The user database 114 may include at least one of a stored address, a preferred route, or a user preference of one or more of the passengers. The stored address, the preferred route, or the user preference of one or more of the passengers may be identified using the user ID.

The driving policy 116 may be communicatively coupled to a perception system 131 and the trajectory controller 118. In addition, the perception system 131 may be communicatively coupled to an external sensor 121. The external sensor 121 may monitor an external environment of the AV. For example, the external sensor 121 may monitor a surface the AV is operating on, a sidewalk proximate the AV, or any other appropriate external environment of the AV. The external sensor 121 may include multiple sensors. For example, the external sensor 121 may include a camera, a microphone, a light detection and ranging sensor, a radio detection and ranging (RADAR) sensor, or any other appropriate sensor.

The external sensor 121 may capture information representative of the external environment of the AV (e.g., raw data). The perception system 131 may receive the information representative of the external environment. In addition, the perception system 131 may generate an external file that includes a rendered representation of the external environment of the AV. The perception system 131 may perform sensor signal processing that includes filtering, denoising, fusion, transformation, or some combination of the raw data received from the external sensor 121 to generate the external file.

The driving policy 116 may receive the external file from the external sensor 121. The driving policy 116 may include a memory (not illustrated in FIG. 1) that stores the external file. The driving policy 116 may forward the external file to the AV navigation system 108. The external text vector may describe spatio-temporal features of the external environment of the AV in text form. The external text vector may provide a world context for the AV navigation system 108.

The AV navigation system 108 may receive the navigational corpus 123 that includes NIs 125. The NIs 125 may correspond to actions that may be performed by the AV, landmarks proximate the AV or the destination, or some combination thereof.

The AV navigation system 108 may receive the instruction text vector from the NLP 106. The AV navigation system 108 may receive the internal file from the DMS 110. In addition, the AV navigation system 108 may receive the external file from the driving policy 116. Alternatively, the AV navigation system 108 may receive the external text vector from the driving policy 116. Further, the AV navigation system 108 may receive the user database 114. The AV navigation system 108 may receive the navigational corpus 123 including the NIs 125.

The AV navigation system 108 may generate the internal text vector based on the internal file or some combination thereof. For example, the DMS 110 may generate the user ID and the AV navigation system 108 may receive the user ID as part of the internal file. The AV navigation system 108 may query the user database 114 using the user ID. In addition, the AV navigation system 108 may generate the external text vector based on the external file. The AV navigation system 108 may include a memory (not illustrated in FIG. 1) that may store the navigational corpus 123, the instruction text vector, the instruction file, the internal file, the internal text vector, the external file, the external text vector, or some combination thereof.

The AV navigation system 108 may generate a sense set based on the instruction text vector, the internal text vector, the external text vector, the user database 114, or some combination thereof. The sense set may include words that correspond to the text within the instruction text vector, the internal text vector, the external text vector, the user database 114, or some combination thereof.

The AV navigation system 108 may compare the words of the sense set to the NIs 125. The AV navigation system 108 may identify a particular NI (e.g., a mapped navigation command) of the NIs 125 that corresponds to the words of the sense set based on the comparison.

The driving policy 116 may receive the particular NI from the AV navigation system 108. The driving policy 116 may provide the particular NI to the safety model 120. The safety model 120 may determine a feasibility of the particular NI based on a legality aspect, a safety aspect, or some combination thereof of the particular NI.

If the safety model 120 approves the particular NI, the driving policy 116 may instruct the trajectory controller 118 to update the navigation plan (e.g., a vehicle trajectory) based on the particular NI. The trajectory controller 118 may update the navigation plan based on the particular NI. In addition, the driving policy 116 may provide feedback (e.g., a safe trajectory message) to the AV navigation system 108, which may forward the feedback to the dialogue manager 104. The dialogue manager 104 may provide the feedback to the user 102 via a speaker (not illustrated in FIG. 1), a display (not illustrated in FIG. 1), or any other appropriate device.

If the safety model 120 does not approve the particular NI, the driving policy 116 may provide feedback (e.g., an unsafe trajectory message) to the AV navigation system 108, which may forward the feedback to the dialogue manager 104. The dialogue manager 104 may provide the feedback to the user 102 via a speaker (not illustrated in FIG. 1), a display (not illustrated in FIG. 1), or any other appropriate device.

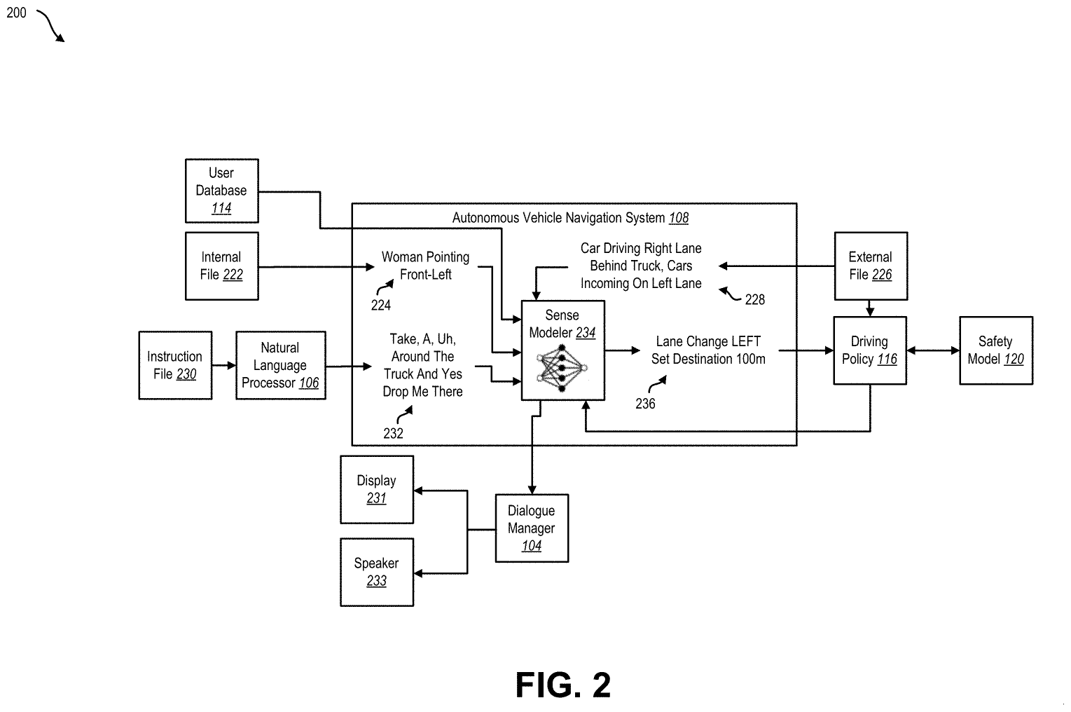

FIG. 2. illustrates a block diagram of another exemplary operating environment 200 of the AV navigation system 108, in accordance with at least one aspect described in the present disclosure. The operational environment 200 may form part of the AV or the environment the AV operates in. The operational environment 200 may include the AV navigation system 108, the NLP 106, the dialogue manager 104, the driving policy 116, and the safety model 120.

The NLP 106 may receive an instruction file 230 representative of the navigation command. The NLP 106 may generate an instruction text vector 232 based on the instruction file 230. For example, as illustrated in FIG. 2, the instruction text vector 232 may include “Take, A, Uh, Around The Truck And Yes Drop Me There.”

The AV navigation system 108 may receive an internal file 222 that includes a rendered representation of the internal environment of the AV. The internal file 222 may be generated by a DMS (not illustrated in FIG. 2). The DMS may correspond to the DMS 110 of FIG. 1. In addition, the AV navigation system 108 may receive the user database 114. The AV navigation system may generate an internal text vector 224 based on the internal file 222. For example, as illustrated in FIG. 2, the internal text vector 224 may include “Woman Pointing Front-Left.”

The AV navigation system 108 may receive an external file 226 that includes a rendered representation of the external environment of the AV. For example, a perception system (not illustrated in FIG. 2) may generate the external file 226. The perception system may correspond to the perception system 131 of FIG. 1. The driving policy 116 may use the external file 226 during decision making processes. In addition, the AV navigation system 108 may generate an external text vector 228 based on the external file 226. For example, as illustrated in FIG. 2, the external text vector 228 may include “Car Driving Right Lane Behind Truck, Cars Incoming On Left Lane.”

The AV navigation system 108 may include a sense modeler 234. The sense modeler 234 may receive the user database 114, the instruction text vector 232, the internal text vector 224, the external text vector 228, or some combination thereof. The sense modeler 234 may generate the sense set based on the internal text vector 224, the user database 114, the instruction text vector 232, the external text vector 228, or some combination thereof.

The sense set may include words based on the internal text vector 224, the user database 114, the instruction text vector 232, the external text vector 228, or some combination thereof. The sense modeler 234 may compare the words of the sense set to the NIs within the navigational corpus (not illustrated in FIG. 2). In some aspects, the AV navigation system 108 may include a memory (not illustrated in FIG. 2) configured to store the navigational corpus 123, the internal text vector 224, the user database 114, the instruction text vector 232, the external text vector 228, or some combination thereof. The sense modeler 234 may identify a particular NI 236 that corresponds to the words of the sense set based on the comparison. For example, as illustrated in FIG. 2, the particular NI 236 may include “Lane Change LEFT Set Destination 100 m.”

The sense modeler 234 may provide the particular NI 236 to the driving policy 116, which may forward the particular NI 236 to the safety model 120. The safety model 120 may determine a feasibility of the particular NI 236 based on a legality aspect, a safety aspect, or some combination thereof of the particular NI 236.

If the safety model 120 approves the particular NI 236, the driving policy 116 may instruct the trajectory controller 118 to update the navigation plan (e.g., a vehicle trajectory) based on the particular NI 236. The trajectory controller 118 may update the navigation plan based on the particular NI 236. In addition, the driving policy 116 may provide feedback (e.g., a navigation response) to the AV navigation system 108, which may forward the feedback to the dialogue manager 104. The dialogue manager 104 may be communicatively coupled to a display 231 and a speaker 233. The dialogue manager 104 may provide the feedback to the user 102 via the speaker 233, the display 231, or any other appropriate device.

If the safety model 120 does not approve the particular NI 236, the driving policy 116 may provide feedback (e.g., an unsafe trajectory message) to the AV navigation system 108, which may forward the feedback to the dialogue manager 104. The dialogue manager 104 may provide the feedback to the user 102 via the speaker 233, the display 231, or any other appropriate device.

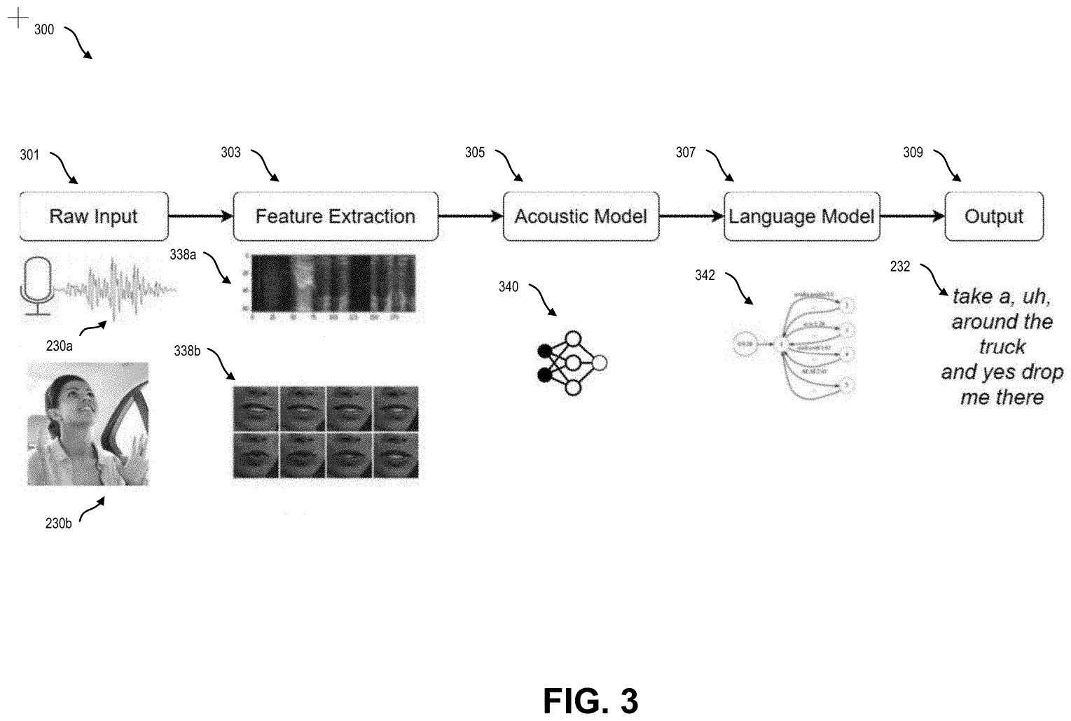

FIG. 3 illustrates a flowchart of an exemplary method 300 to generate the instruction text vector 232, in accordance with at least one aspect described in the present disclosure. The method 300 may be performed by any suitable system, apparatus, or device with respect to generating the instruction text vector 232 using the instruction file 230. For example, the AV navigation system 108, the NLP 106, the dialogue manager 104, or some combination thereof of FIGS. 1 and 2 may perform or direct performance of one or more of the operations associated with the method 300. The method 300 is described in relation to FIG. 3 as being performed by the NLP 106 for example purposes. The method 300 may include one or more blocks 301, 303, 305, 307, and 309. Although illustrated with discrete blocks, the operations associated with one or more of the blocks of the method 300 may be divided into additional blocks, combined into fewer blocks, or eliminated, depending on the particular implementation. The method 300 may describe processing a user utterance using a natural language understanding pipeline using audio modality or combining multiple modalities.

At block 301, the NLP 106 may receive the instruction file 230 (e.g., raw input). The instruction file 230 may include an audio portion 230a, a video portion 230b, or some combination thereof. At block 303, the NLP 106 may extract features 338 from the instruction file 230. For example, the NLP 106 may extract mel frequency cepstral coefficients (MFCC) features 338a from the audio portion 230a and lip positions features 338b from the video portion 230b.

At block 305, the NLP 106 may perform acoustic modeling on the extracted features 338 to generate an acoustic model 340. At block 307, the NLP 106 may perform language modelling on the acoustic model 340 to generate a language model 342. The NLP 106 may generate the language model 342 in text form. The language model 342 may correspond to the instruction text vector 232. At block 309, the NLP 106 may provide the instruction text vector 232 to the AV navigation system 108.

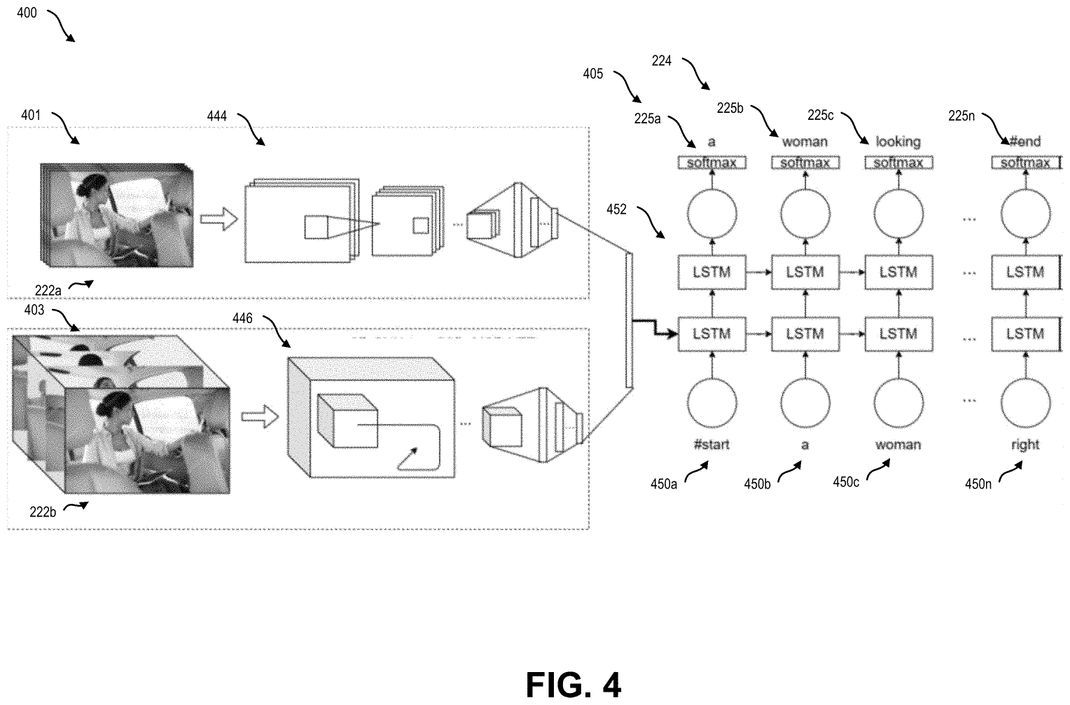

FIG. 4 illustrates a flowchart of a method 400 to extract features from the internal file 222 and generate the internal text vector 224, in accordance with at least one aspect described in the present disclosure. The method 400 may be performed by any suitable system, apparatus, or device with respect to extracting features from the internal file 222 and generating the internal text vector 224. For example, the AV navigation system 108, the NLP 106, the dialogue manager 104, or some combination thereof of FIGS. 1 and 2 may perform or direct performance of one or more of the operations associated with the method 400. The method 400 is described in relation to FIG. 4 as being performed by the AV navigation system 108 for example purposes. The method 400 may include one or more blocks 401, 403, and 405. Although illustrated with discrete blocks, the operations associated with one or more of the blocks of the method 400 may be divided into additional blocks, combined into fewer blocks, or eliminated, depending on the particular implementation. The method 400 may describe processing the internal file 222 to complement the navigation command with context of the internal environment of the AV.

At block 401, the AV navigation system 108 may extract a portion of features (e.g., spatio-temporal features) 450a-n from a frames portion 222a of the internal file 222. The AV navigation system 108 may extract the features 450a-n using a two dimensional (2D) convoluted neural network (CNN) 444.

At block 403, the AV navigation system 108 may extract a portion of the features 450a-n from a temporal sequence portion 222b of the internal file 222. The AV navigation system 108 may extract the features 450a-n using a three-dimensional (3D) CNN 446.

At block 405, the AV navigation system 108 (e.g., the 2D CNN 444 and the 3D CNN 446) may feed the extracted features 450a-n into a long short-term memory (LSTM) array 452. The LSTM array 452 may form a recurrent neural network (RNN). In addition, the LSTM array 452 may generate the internal text vector 224. The LSTM array 452 may generate the internal text vector 224 in text form that includes multiple words 225a-n. Alternatively, a transformer model may be use instead of the LSTM array 452.

The LSTM array 452 may preserve temporal aspects of the internal file 222 in the internal text vector 224. The internal text vector 224 may include a text description of the internal environment of the AV in a windowed manner (with the description being a number of frames per second).

In the illustrated implementation, the internal text vector 224 includes a first word 225a, a second word 225b, a third word 225c, and a Nth word 225n (generally referred to in the present disclosure as “words 225”). As indicated by the ellipsis and the Nth word 225n in FIG. 4, the internal text vector 224 may include any appropriate number of words 225.

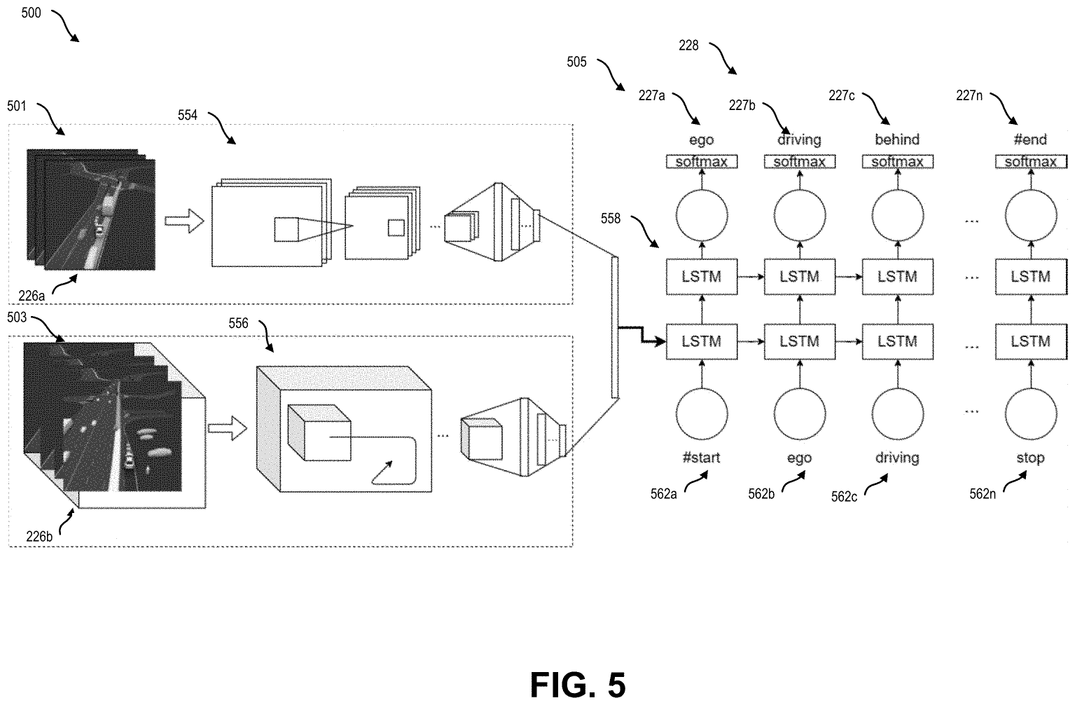

FIG. 5 illustrates a flowchart of a method 500 to extract features from the external file 226 and generate the external text vector 228, in accordance with at least one aspect described in the present disclosure. The method 500 may be performed by any suitable system, apparatus, or device with respect to extracting features from the external file 226 and generating the external text vector 228. For example, the AV navigation system 108, the NLP 106, the dialogue manager 104, or some combination thereof of FIGS. 1 and 2 may perform or direct performance of one or more of the operations associated with the method 500. The method 500 is described in relation to FIG. 5 as being performed by the AV navigation system 108 for example purposes. The method 500 may include one or more blocks 501, 503, and 505. Although illustrated with discrete blocks, the operations associated with one or more of the blocks of the method 500 may be divided into additional blocks, combined into fewer blocks, or eliminated, depending on the particular implementation. The method 500 may describe processing the external file 226 to complement the navigation command with context of the external environment of the AV.

At block 501, the AV navigation system 108 may extract a portion of features (e.g., spatio-temporal features) 562a-n from a frames portion 226a of the external file 226. The AV navigation system 108 may extract the features 562a-n using a 2D CNN 554. At block 503, the AV navigation system 108 may extract a portion of the features 562a-n from a temporal sequence portion 226b of the external file 226. The AV navigation system 108 may extract the features 562a-n using a 3D CNN 556.

At block 505, the AV navigation system 108 (e.g., the 2D CNN 554 and the 3D CNN 556) may feed the extracted features 562a-n into a LSTM array 558. The LSTM array 558 may form an RNN. In addition, the LSTM array 558 may generate the external text vector 228. The LSTM array 558 may generate the external text vector 228 in text form that includes multiple words 227a-n. Alternatively, a transformer model may be use instead of the LSTM array 558.

The LSTM array 558 may preserve temporal aspects of the external file 226 in the external text vector 228. The external text vector 228 may include a text description of the external environment of the AV in a windowed manner (with the description being a number of frames per second).

In the illustrated implementation, the external text vector 228 includes a first word 227a, a second word 227b, a third word 227c, and a Nth word 227n (generally referred to in the present disclosure as “words 227”). As indicated by the ellipsis and the Nth word 227n in FIG. 5, the external text vector 228 may include any appropriate number of words 227.

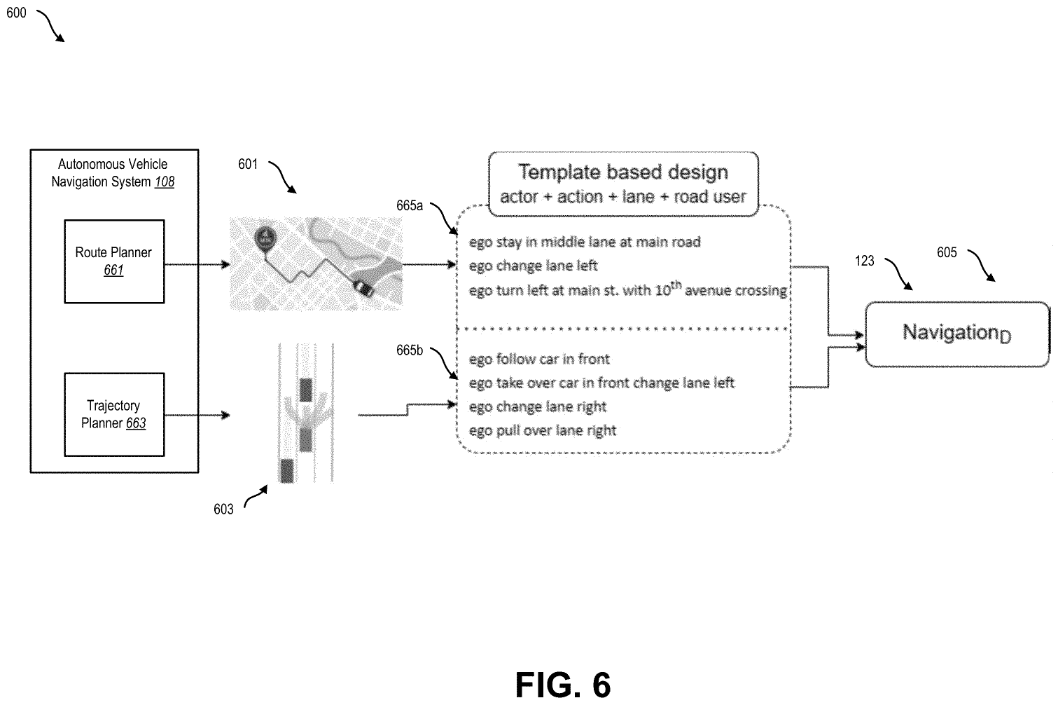

FIG. 6 illustrates a flowchart of a method 600 to generate the navigational corpus 123, in accordance with at least one aspect described in the present disclosure. The method 600 may be performed by any suitable system, apparatus, or device with respect to generating the navigational corpus 123. For example, the AV navigation system 108, the NLP 106, the dialogue manager 104, or some combination thereof of FIGS. 1 and 2 may perform or direct performance of one or more of the operations associated with the method 600. The method 600 is described in relation to FIG. 6 as being performed by the AV navigation system 108 for example purposes. The method 600 may include one or more blocks 601, 603, and 605. Although illustrated with discrete blocks, the operations associated with one or more of the blocks of the method 600 may be divided into additional blocks, combined into fewer blocks, or eliminated, depending on the particular implementation. The method 600 may generate the navigational corpus 123 to include a set of navigational sequences that describe capabilities of the AV.

The AV navigation system 108 may include a route planner 661 and a trajectory planner 663. At block 601, the route planner 661 may generate a particular number of subsequent NIs (e.g., segments) in text form (e.g., actor, action, lane, road-user) 665a as a dictionary of NIs. The subsequent NIs may form part of the navigation route. At block 603, the trajectory planner 663 may generate a particular number of possible NIs (e.g., segments) for a pre-defined future window in text form 665b. At block 605, the AV navigation system 108 may output the subsequent NIs in text form 665a and the possible NIs for the pre-defined future window in text form 665b as the navigational corpus 123.

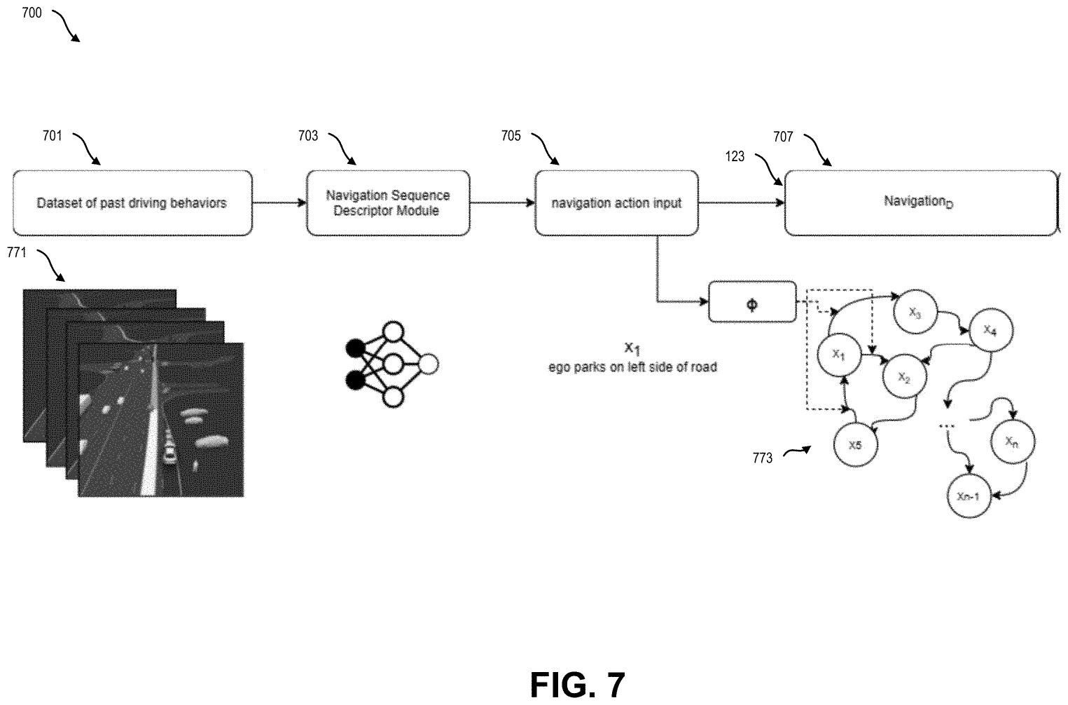

FIG. 7 illustrates a flowchart of a method 700 to generate a navigation action diagram 773 based on a known driving dataset 771, in accordance with at least one aspect described in the present disclosure. The method 700 may be performed by any suitable system, apparatus, or device with respect to generating the navigation action diagram 773 and the navigational corpus 123. For example, the AV navigation system 108, the NLP 106, the dialogue manager 104, or some combination thereof of FIGS. 1 and 2 may perform or direct performance of one or more of the operations associated with the method 700. The method 700 is described in relation to FIG. 7 as being performed by the AV navigation system 108 for example purposes. The method 700 may include one or more blocks 701, 703, 705, and 707. Although illustrated with discrete blocks, the operations associated with one or more of the blocks of the method 700 may be divided into additional blocks, combined into fewer blocks, or eliminated, depending on the particular implementation. The method 700 may generate the navigational corpus 123 and the navigation action graph 773 to include a set of navigational sequences that describe capabilities of the AV.

At block 701, the AV navigation system 108 may receive the known driving dataset 771. At block 703, the AV navigation system 108 may generate a navigation sequence model using the known driving dataset 771. At block 705, the AV navigation system 108 may generate the navigation action graph 773 and the navigational corpus 123. The AV navigation system may encode the navigation sequence model to a graph where actions in a road context become nodes and similarity relationships between the actions are represented as edges. The edges may be calculated using a similarity function Φ according to Equation 2. Nodes that include similar navigation behaviors may include higher edge weights

Φ(x)=wₓ+bₓ Equation 2

In Equation 2, w represents a weight term and b represents a bias term. Equation 2 may correspond to an affine function. Edge weight between nodes (e.g., xᵢ and xⱼ) may be determined according to Equation 3.

Gᵢⱼ=f(Φ(xᵢ),Φ(xⱼ)) Equation 3

In Equation 3, f( ) represents a cosine similarity.

At block 707, the AV navigation system 108 may output the navigational corpus 123 and the navigation action graph 773.

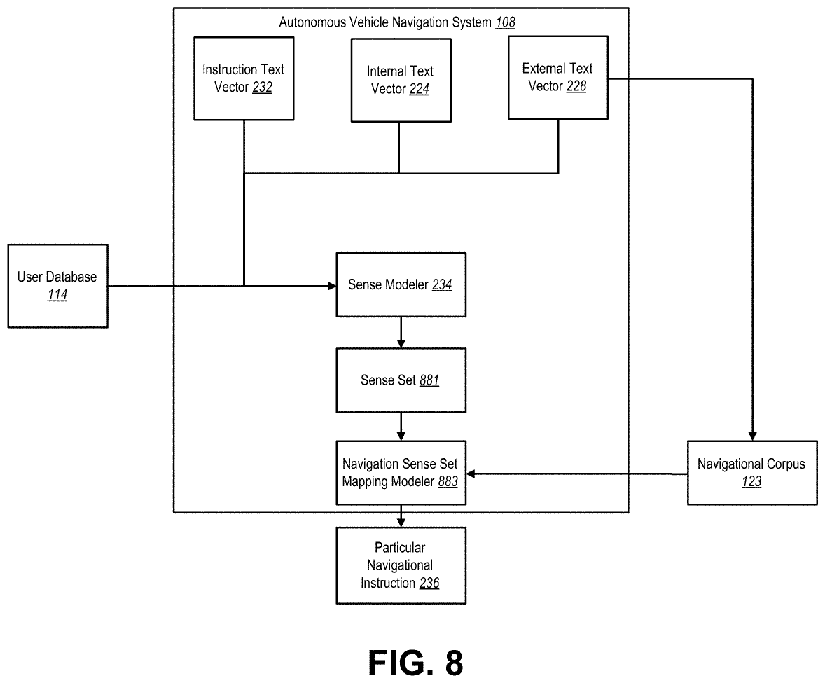

FIG. 8 illustrates a blocking diagram of the AV navigation system 108 determining the particular NI 236 based on text vectors 232, 224, 226, in accordance with at least one aspect described in the present disclosure. The sense modeler 234 may receive the instruction text vector 232, the internal text vector 224, the external text vector 228, the user database 114, the navigation corpus 123, or some combination thereof.

The instruction text vector 232 may include a vector of words represented as (u1, u2, . . . un) (e.g., “Take Uh, Around The Truck And Drop Me There”). The internal text vector 224 may include a vector of words represented as (c1, c2, . . . cn) (e.g., “Woman Looking Front Pointing Finger At Right”). The external text vector 228 may include a vector of words represented as (t1, t2, . . . tn) (e.g., “Ego On Right Lane Following Truck And Vehicle On Left Lane”).

The sense modeler 234 may generate a sense set 881 based on the instruction text vector 232, the internal text vector 224, the external text vector 228, the user database 114, or some combination thereof. The sense set 881 may include words that correspond to the text within the instruction text vector 232, the internal text vector 224, the external text vector 228, the user database 114, or some combination thereof.

The AV navigation system 108 may include a navigation sense mapping modeler 883. The navigation sense mapping modeler 883 may receive the navigational corpus 123. The navigational corpus 123 may include the NIs 125 (not illustrated in FIG. 8), which may be further specified based on the external text vector 228. The navigation sense mapping modeler 883 may compare the words of the sense set 883 to the NIs 125. The navigation sense mapping modeler 883 may identify the particular NI 236 of the NIs 125 that corresponds to the words of the sense set 883 based on the comparison.

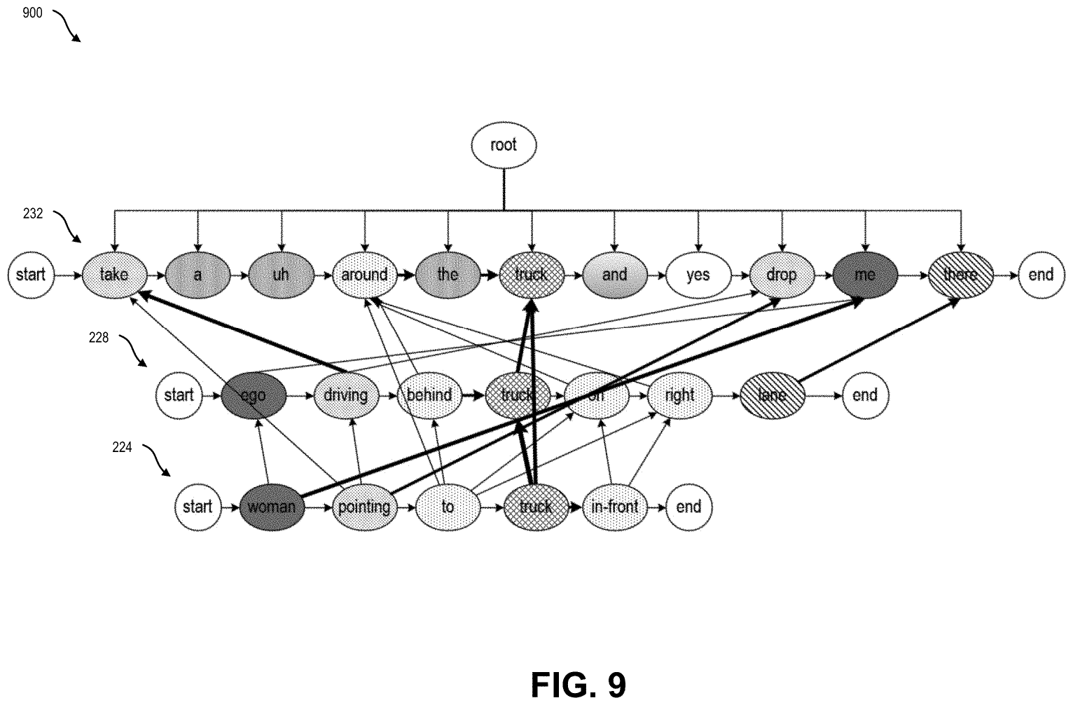

FIG. 9 illustrates an exemplary weighted graph 900 to generate a sense set, in accordance with at least one aspect described in the present disclosure. The weighted graph 900 may include the instruction text vector 232, the internal text vector 224, the external text vector 228, or some combination thereof. Each of the text vectors 232, 224, 228 may include words that are connected using weighted edges 991. A first edge is denoted as 991a and a second edge is denoted as 991b to illustrate example edges. A weighting of the edges 991 may correspond to a thickness of the edge 991 as illustrated in FIG. 9. For example, the first edge 991a may be greater than a weighting of the second edge 991b.

As illustrated in FIG. 9, the words of the internal text vector 224 may be mapped to the words of the external text vector 228 and the words of the instruction text vector 232. In addition, as illustrated in FIG. 9, the words of the external text vector 228 may be mapped to the words of the instruction text vector 232. The sense set may include a vector of words that are based on the mapping as illustrated in FIG. 9.

An AV navigation system may be configured to cause an AV to follow a navigation route according to NIs. The NIs may be based on a destination input provided by a user or other entity. The destination input may be provided based on a point of interest (POI) selected by the user. The AV navigation system may identify the POI based on a geographical location (e.g., an address) or semantic tag linked to an individual position on a map. The destination input may be provided by the user using various devices including a knob selector, a keyboard integrated into the AV navigation system, verbal instructions (e.g., “drive me to Olympia Park in Munich”), an input device integrated into an external computing device, or some combination thereof.

The user may provide a navigation command to the AV navigation system to update the navigation route, the NIs, or some combination thereof (e.g., change the trajectory of the AV) while the AV is in motion. The navigation command may be provided using a haptic device, a dialogue manager (e.g., an NLP), or some combination thereof. Examples of the haptic devices may include an actuating blinker signal that indicates or confirms a lane change or a forced feedback device.

The navigation command may include navigational cues (e.g., “stop there,” “take a right turn,” or “park behind that car”), an updated destination, a last-mile navigational cue, or some combination thereof. Examples of the navigation command include “pull up to the curb, I don't know maybe in 50 feet?”, “can you go on the next, uh, entrance?”, “can you pull up about 20 feet and around the bus and drop me off?”, “there is right, park to my left or right.”

An external environment of the AV may dynamically change, which may impact how the user provides the navigation command. Further, extraneous circumstances may also impact how the user provides the navigation command.

The AV navigation system may identify a particular NI that corresponds to the navigation command. For example, the navigation command may include “change lane to the right” and the AV navigation system may identify the particular NI as “initiate lane-change maneuver to immediate right lane if right lane exists and it is safe.” The AV navigation system may update the navigation plan based on the particular NI.

The navigation command may include natural language provided by the user. For example, the natural language may be spoken or typed by the user. The navigation command may not include specific instruction constructs that clearly describe the update that is to be made to the navigation plan. In addition, the navigation command may not include context related to the AV or the user. The lack of specific instructions or context may cause the navigation command to be ambiguous to the AV navigation system. The navigation command may be ambiguous to the AV navigation system due to multiple reasons. For example, the navigation command may include grammatical errors, language subtleties, or other language nuances.

The AV navigation system may map the navigation command to the NIs to identify the particular NI. However, if the navigation command is ambiguous, the AV navigation system may incorrectly map the navigation command.

Some dialogue management technologies may implement intent recognition, conversational loops, or some combination thereof to resolve ambiguous commands. An example of a conversational loop

Some aspects described in the present disclosure may determine an intent of the user based on the navigation command and features of the external environment, the internal environment, or some combination thereof of the AV.

The AV navigation system may include a disambiguator that operates as a bridge between an WI, a route planner, and a driving policy of the AV. The AV navigation system may disambiguate the navigation command by mapping words of the navigation command to the NIs that are interpretable by the route planner, the diving policy, or some combination thereof. The AV navigation system may map words of the navigation command to the NIs of a navigational corpus according to Equation 1.

The AV navigation system may identify the particular NI using a navigational corpus that includes the NIs, the features of the external environment extracted from an external file, the features of the internal environment extracted from an internal file, or some combination thereof. The AV navigation system may identify a closest NI to update the navigation plan.

The AV navigation system may disambiguate the navigation command even if the navigation command is ambiguous or includes improperly constructed sentences. The AV navigation system may identify the intent of the user by performing word sense and sentence disambiguation.

The AV navigation system may implement a conversational user interface and context input. The context input may be highlighted on the navigation command to resolve ambiguities in the navigation command. The AV navigation system may operate as an arbitration system that bridges an interpretation of the user intent and the driving policy.

A navigational corpus may include sequences of NIs. The AV navigation system may translate features of the external environment from the driving policy to spatio-temporal descriptions. The spatio-temporal descriptions may be mapped against the navigation command to find a match between the NIs and the navigation command. The AV navigation system may similarly transform in cabin models into navigational descriptions, which may be mapped against the navigation command.

The AV navigation system may receive input as text from the NLP based on an utterance by the user. The AV navigation system may also receive in-cabin context from a DMS camera or similar sensor. In addition, the AV navigation system may receive external context from external sensors and the driving policy. The AV navigation system may generate in-cabin and world scene descriptions using a transformer CNN to extract features and attend to following a template based navigational sentence form. The AV navigation system may receive a user database that includes prior knowledge about a user such addresses corresponding home, work, etc.

The AV navigation system may map user intent from the utterance to a driving policy interpretable NI that links verbs to maneuvers, nouns to landmarks and adjectives and gestures to behavioral modifiers (e.g. proximity). The driving policy may perform a check on the particular NI and may provide feedback (negative or positive) with the closest possible legal NI back to the AV navigation system. The particular NI may be provided to the in-vehicle infotainment system which may display the generated NI via spoken utterance back to the user and/or making use of the in-cabin displays.

The AV navigation system may include a memory having computer-readable instructions stored thereon. The AV navigation system may also include a processor operatively coupled to the memory. The processor may be configured to read and execute the computer-readable instructions to perform or control performance of operations. The AV navigation system may receive an external file that includes a rendered representation of an external environment of the AV. The external file may include multi-modal information (e.g., video plus audio). The external file may be stored in the memory of the AV navigation system. The external file may be rendered in 2D or 3D.

The AV navigation system may also receive an internal file that includes a rendered representation of an internal environment of the AV. The internal file may include multi-modal information (e.g., video plus audio). The internal file may be stored in the memory of the AV navigation system. The internal file may be rendered in 2D or 3D. The internal environment may correspond to an in-cabin environment of the AV.

The AV navigation system may receive an instruction file. The instruction file may be representative of the navigation command provided by the user in natural language. The navigation command may correspond to a user-initiated instruction. The internal file, the external file, and the instruction file may correspond to a similar period of time. The navigation command may be spoken by the user or input by the user using a keyboard or other input device. The instruction file may include multi-modal information (e.g., video plus audio).

The AV navigation system may receive a user database. The user database may include at least one of a stored address, a preferred route, or a user preference. For example the user database may include “home—123 Main str.” “work—456 Sky Drive.” The user database may include information in graph form.

The AV navigation system may receive an environment text vector. The environment text vector may be representative of a spatio-temporal feature of an environment of the AV. The environment text vector may correspond to the internal text vector, the external text vector, or some combination thereof.

The AV navigation system may extract features of the external environment from the external file. The AV navigation system may also generate the external text vector based on the external file. The external text vector may describe a spatio-temporal feature of the external environment of the AV in text form. The external text vector may include a first set of words. The external text vector may be based on the features of the external environment.

The AV navigation system may extract features of the internal environment from the internal file. The AV navigation system may generate the internal text vector based on the internal file. The internal text vector may describe a spatio-temporal feature of the internal environment of the AV in text form. The internal text vector may include a third set of words. The internal text vector may be based on the plurality of features of the internal environment. The environment text vector may include at least one of the external text vector or the internal text vector.

The AV navigation system may receive an instruction text vector. The instruction text vector may be representative of the navigation command for the AV provided by the user in natural language. The AV navigation system may generate the instruction text vector based on the instruction file. The instruction text vector may describe the navigation command provided by the user in text form. The instruction text vector may include a second set of words.

The AV navigation system may generate a sense set. The sense set may include a set of words based on the instruction text vector and the environment text vector. Not all the words in the instruction text vector may include the same weight (e.g., some words may include filler words or broken words). The sense set may be formed from the internal text vector, the external text vector, the instruction text vector, the user database, or some combination thereof. The sense set may permit the navigation command to be mapped to the context of the environment of the AV (e.g., when the user points to the right as an intended parking destination but does not specify the words in the navigation command or when the user does not qualify that a bus to take over is the bus immediately in front of them).

The instruction text vector, the external text vector, or the internal text vector may each include graphs in which each word (e.g., token) is categorized (e.g., verb, noun, adverb, preposition, etc.). A distance between the words (e.g., the tokens) in the graphs may be based on their category and position in the navigation command. Worsd2vec may be used to generate the graphs and weight the edges. In addition, further context may be provided via the user database. A current graph and a prior knowledge graph may be merged to generate the sense set so that tokens can be mapped and weighted.

The graphs may be used to generate the sense set. For example, the sense set may include “Start+Ego+Driving+around+the+truck+drop+right+lane+end.”

To generate the sense set, the AV navigation system may map at least a portion of the words of the first set of words to one or more words of the second set of words. In addition, the AV navigation system may map at least a portion of the words of the third set of words to one or more words of the second set of words. The words of the sense set may include the second set of words, the mapped words of the first set of words, and the mapped words of the third set of words. The sense set may be generated further based on the user database.

The AV navigation system may compare the words of the sense set to NIs within the navigational corpus. To compare the words of the sense set to the NIs, the AV navigation system may identify a word type of each of the words of the sense set. Each of the words of the sense set may be mapped to the NIs based on the corresponding word type. The navigational corpus may include actions that can be performed by the AV and landmarks proximate the AV or a destination. The navigational corpus may filter particular NIs that correspond to the navigation command. The actions within the navigational corpus may include high level actions and verbs such as “turn right,” “turn left,” “merge right,” “accelerate,” “brake,” etc. The NIs may include low level and specific instructions such as “turn right on Pacific Coast Highway,” “exit the freeway in 400 meters,” etc.

The AV navigation system may determine the particular NI (e.g., a best intended navigation instruction). The AV navigation system may identify the particular NI that corresponds to the words of the sense set based on the comparison. If the NIs are stored using a dictionary method, the navigation corpus may already be based on current features of the external environment. If the NIs are stored using a graph, additional filtering may be performed to reduce mapping space to be searched. The additional filtering of the NIs may reduce computational resources and may set a shorter horizon window for navigation planning in the dictionary method.

To identify the particular NI, the AV navigation system may map a verb of the words of the sense set to an action listed in the navigational corpus. In addition, the AV navigation system may map a noun of the words of the sense set to a landmark listed in the navigational corpus.

The AV navigation system may map the words of the sense set to the NIs of the navigational corpus according to Equation 4.

s′=argmax siϵNavigationD(wi)Score(si) Equation 4

In Equation 4, Navigation_{D} represents the navigational corpus, Sᵢ represents the sense set in which i represents a positive integer representative of a maximum number of sense sets to be included in the calculation, and Score represents a value. The positive integer representative of the maximum number of sense sets may be pre-configured or configurable. The Score value may be determined based on:
1. an NI that corresponds to a feature score based on a maximum likelihood estimate;
2. an NI that corresponds to a feature score based on a maximum probability; or
3. an optimization algorithm configured to determine a most relevant portion of the text vectors and a corresponding NI of the plurality of NIs.

If the NIs of the navigational corpus are stored using a dictionary method, Score may be computed as an NI (e.g., an element) in the dictionary with a highest feature score (e.g., a maximum likelihood estimate) or the NI in the dictionary with a maximum probability (e.g., using a Naïve Bayes classifier). If the NIs of the navigational corpus are store using a graph method, Score may be determined by applying an optimization algorithm to find the relevant node(s) to the given input and output the corresponding NI.

If more than one NI corresponds to the navigation command within a pre-defined weight threshold, all of the corresponding NIs may be included and provided to the user in a weighted order.

The AV navigation system may determine a feasibility of the particular NI based on a legality aspect or a safety aspect of the particular NI. Alternatively a safety model may determine the feasibility of the particular NI. The safety model may include a behavioral safety checker to determine the legality (i.e., safety) of the particular NI.

If the safety model approves the particular NI, a driving policy of the AV may arrange the particular NI as a subsequent instruction of the navigation plan. If the safety model does not approve the particular NI, feedback may be provided to the user indicating an infringement of the particular NI. The feedback may also be provided to the user.

The AV navigation system may update a vehicle trajectory of the AV based on the particular NI. The AV navigation system may cause a trajectory controller to change the vehicle trajectory of the AV.

The AV navigation system may receive the navigational corpus. The navigational corpus may include the actions that the AV can perform. The AV may determine, based on at least one of the environment text vector and the instruction text vector, a current action, a current scenario, a current NI, or a current external environment of the AV. The AV navigation system may filter the actions of the navigation corpus based on at least one of the current action, the current scenario, the current NI, or the current external environment.

A non-transitory computer-readable medium may include computer-readable instructions stored thereon that are executable by a processor to perform or control performance of operations. The operations may include receive the instruction text vector representative of the navigation command for the AV provided by the user in natural language. The operations may also include receive the environment text vector representative of the spatio-temporal feature of the environment of the AV. In addition, the operations may include generate the sense set. The sense set may include words based on the instruction text vector and the environment text vector. Further, the operations may include compare the words of the sense set to the set of NIs within the navigational corpus. The operations may include identify the particular NI of the set of NIs that corresponds to the words of the sense set based on the comparison. The operations may also include update the vehicle trajectory of the AV based on the particular NI.

The operations may further include receive the external file including the rendered representation of the external environment of the AV. The operations may also include generate the external text vector based on the external file. The external text vector may describe the spatio-temporal feature of the external environment of the AV in text form. The operations may include receive the internal file including the rendered representation of the internal environment of the AV. The operations may include generate the internal text vector based on the internal file. The internal text vector may describe the spatio-temporal feature of the internal environment of the AV in text form.

The operations may include receive the instruction file. The instruction file may be representative of the navigation command provided by the user in natural language. The operations may also include generate the instruction text vector based on the instruction file. The instruction text vector may describe the navigation command provided by the user in text form. The environment text vector may include at least one of the external text vector or the internal text vector.

The operations may also include extract features of the external environment from the external file. The external text vector may be based on the features of the external environment. The operations may include extract features of the internal environment from the internal file. The internal text vector may be based on the features of the internal environment.

The external text vector may include the first set of words. The instruction text vector may include the second set of words. The internal text vector may include the third set of words. The operation generate the sense set may include map at least a portion of the words of the first set of words to one or more words of the second set of words. The operation generate the sense set may also include map at least a portion of the words of the third set of words to one or more words of the second set of words. The words of the sense set may include the second set of words, the mapped word of the first set of words, and the mapped word of the third set of words.

The operations may include receive the user database. The user database may include at least one of the stored address, the preferred route, or the user preference. The sense set may further be generated based on the user database.

The operations may include receive the navigational corpus. The navigational corpus may include the set of actions that the AV can perform. The operations may also include determine the external text vector, the internal text vector, the current action, the current scenario, the current NI, or the current external environment of the AV based on the instruction text vector. The operations may further include filter the actions based on at least one of the current action, the current scenario, the current NI, or the current external environment.

The operations may include determine the feasibility of the particular NI based on the legality aspect or the safety aspect of the particular NI.

A system may include means to receive the instruction text vector. The instruction text vector may be representative of the navigation command for the AV provided by the user in natural language. The system may also include means to receive the environment text vector representative of the spatio-temporal feature of the environment of the AV. In addition, the system may include means to generate the sense set. The sense set may include words based on the instruction text vector and the environment text vector. The system may further include means to compare the words of the sense set to NIs within the navigational corpus. The system may include means to identify the particular NI of the plurality of NIs that corresponds to the plurality of words based on the comparison. The system may also include means to update the vehicle trajectory of the AV based on the particular NI.

The system may include means to receive the external file. The external file may include the rendered representation of the external environment of the AV. The system may also include means to generate the external text vector based on the external file. The external text vector may describe the spatio-temporal feature of the external environment of the AV in text form. In addition, the system may include means to receive the internal file. The internal file may include the rendered representation of the internal environment of the AV. The system may further include means to generate the internal text vector based on the internal file. The internal text vector may describe the spatio-temporal feature of the internal environment of the AV in text form.

The system may include means to receive the instruction file. The instruction file may be representative of the navigation command provided by the user in natural language. The system may also include means to generate the instruction text vector based on the instruction file. The instruction text vector may describe the navigation command provided by the user in text form. The environment text vector may include at least one of the external text vector or the internal text vector.

The system may include means to extract features of the external environment from the external file. The external text vector may be based on the features of the external environment. The system may also include means to extract features of the internal environment from the internal file. The internal text vector may be based on the features of the internal environment.

The system may include means to receive the user database. The user database may include at least one of the stored address, the preferred route, or the user preference. The sense set may be generated further based on the user database.

The system may include means to receive the navigational corpus. The navigational corpus may include actions that the AV can perform. The system may also include means to determine the current action, the current scenario, the current NI, or the current external environment of the AV based on the plurality of text vectors. In addition, the system may include means to filter the actions based on the current action, the current scenario, the current NT, or the current external environment.

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to aspects containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although aspects of the present disclosure have been described in detail, various changes, substitutions, and alterations could be made hereto without departing from the spirit and scope of the present disclosure.

What is claimed is:

1. An autonomous vehicle (AV) navigation system comprising:
a memory having computer-readable instructions stored thereon; and
a processor operatively coupled to the memory and configured to read and execute the computer-readable instructions to perform or control performance of operations comprising:
receive an instruction text vector representative of a navigation command for an AV provided by a user in natural language;
receive an environment text vector representative of a spatio-temporal feature of an environment of the AV;
generate a sense set comprising a plurality of words based on the instruction text vector and the environment text vector;
compare the plurality of words of the sense set to a plurality of navigational instructions (NIs) within a navigational corpus;
identify a particular NI of the plurality of NIs that corresponds to the plurality of words based on the comparison; and
update a vehicle trajectory of the AV based on the particular NI.

2. The AV navigation system of claim 1, the operations further comprising:
receive an external file comprising a rendered representation of an external environment of the AV;
generate an external text vector based on the external file that describes a spatio-temporal feature of the external environment of the AV in text form;
receive an internal file comprising a rendered representation of an internal environment of the AV;
generate an internal text vector based on the internal file that describes a spatio-temporal feature of the internal environment of the AV in text form;
receive an instruction file representative of the navigation command provided by the user in natural language; and
generate the instruction text vector based on the instruction file that describes the navigation command provided by the user in text form, wherein the environment text vector comprises at least one of the external text vector or the internal text vector.

3. The AV navigation system of claim 2, wherein the operations further comprise:
extract a plurality of features of the external environment from the external file, wherein the external text vector is based on the plurality of features of the external environment; and
extract a plurality of features of the internal environment from the internal file, wherein the internal text vector is based on the plurality of features of the internal environment.

4. The AV navigation system of claim 2, wherein:
the external text vector comprises a first plurality of words, the instruction text vector comprises a second plurality of words, and the internal text vector comprises a third plurality of words; and
the operation generate the sense set comprises:
map a word of the first plurality of words to a word of the second plurality of words; and
map a word of the third plurality of words to a word of the second plurality of words, wherein the plurality of words of the sense set comprises the second plurality of words, the mapped word of the first plurality of words, and the mapped word of the third plurality of words.

5. The AV navigation system of claim 1, wherein the operations further comprise receive a user database comprising at least one of a stored address, a preferred route, or a user preference, wherein the sense set is generated further based on the user database.

6. The AV navigation system of claim 1, wherein the operations further comprise:
receive the navigational corpus, the navigational corpus comprising a plurality of actions that the AV can perform;
determine, based on at least one of the environment text vector or the instruction text vector, a current action, a current scenario, a current NI, or a current external environment of the AV; and
filter the plurality of actions based on at least one of the current action, the current scenario, the current NI, or the current external environment.

7. The AV navigation system of claim 1, wherein the particular NI is determined according to:
$${arg max}_{{S}_{i} ∈ N a v i g a t i o {n}_{D ( {w}_{i} )}} Score ( {S}_{i} )$$
in which Navigation_{D} represents the navigational corpus, Sᵢ represents the sense set and in which i represents a positive integer representative of a maximum number of sense sets to be included in the calculation, and Score represents a value that is determined based on:
an NI of the plurality of NIs that corresponds to a feature score based on a maximum likelihood estimate;
an NI of the plurality of NIs that corresponds to a feature score based on a maximum probability; or
an optimization algorithm configured to determine a most relevant portion of at least one of the environment text vector, the instruction text vector, or a corresponding NI of the plurality of NIs.

8. The AV navigation system of claim 1, wherein the operations further comprise determine a feasibility of the particular NI based on a legality aspect or a safety aspect of the particular NI.

9. A non-transitory computer-readable medium having computer-readable instructions stored thereon that are executable by a processor to perform or control performance of operations comprising:
receive an instruction text vector representative of a navigation command for an AV provided by a user in natural language;
receive an environment text vector representative of a spatio-temporal feature of an environment of the AV;
generate a sense set comprising a plurality of words based on the instruction text vector and the environment text vector;
compare the plurality of words of the sense set to a plurality of navigational instructions (NIs) within a navigational corpus;
identify a particular NI of the plurality of NIs that corresponds to the plurality of words based on the comparison; and
update a vehicle trajectory of the AV based on the particular NI.

10. The non-transitory computer-readable medium of claim 9, the operations further comprising:
receive an external file comprising a rendered representation of an external environment of the AV;
generate an external text vector based on the external file that describes a spatio-temporal feature of the external environment of the AV in text form;
receive an internal file comprising a rendered representation of an internal environment of the AV;
generate an internal text vector based on the internal file that describes a spatio-temporal feature of the internal environment of the AV in text form;
receive an instruction file representative of the navigation command provided by the user in natural language; and
generate the instruction text vector based on the instruction file that describes the navigation command provided by the user in text form, wherein the environment text vector comprises at least one of the external text vector or the internal text vector.

11. The non-transitory computer-readable medium of claim 10, wherein the operations further comprise:
extract a plurality of features of the external environment from the external file, wherein the external text vector is based on the plurality of features of the external environment; and
extract a plurality of features of the internal environment from the internal file, wherein the internal text vector is based on the plurality of features of the internal environment.

12. The non-transitory computer-readable medium of claim 10, wherein:
the external text vector comprises a first plurality of words, the instruction text vector comprises a second plurality of words, and the internal text vector comprises a third plurality of words; and
the operation generate the sense set comprises:
map a word of the first plurality of words to a word of the second plurality of words; and
map a word of the third plurality of words to a word of the second plurality of words, wherein the plurality of words of the sense set comprises the second plurality of words, the mapped word of the first plurality of words, and the mapped word of the third plurality of words.

13. The non-transitory computer-readable medium of claim 9, wherein the operations further comprise receive a user database comprising at least one of a stored address, a preferred route, or a user preference, wherein the sense set is generated further based on the user database.

14. The non-transitory computer-readable medium of claim 9, wherein the operations further comprise:
receive the navigational corpus, the navigational corpus comprising a plurality of actions that the AV can perform;
determine, based on at least one of the environment text vector or the instruction text vector, a current scenario, a current NI, or a current external environment of the AV; and
filter the plurality of actions based on at least one of the current action, the current scenario, the current NI, or the current external environment.

15. The non-transitory computer-readable medium of claim 9, wherein the operations further comprise determine a feasibility of the particular NI based on a legality aspect or a safety aspect of the particular NI.

16. A system, comprising:
means to receive an instruction text vector representative of a navigation command for an AV provided by a user in natural language;
means to receive an environment text vector representative of a spatio-temporal feature of an environment of the AV;
means to generate a sense set comprising a plurality of words based on the instruction text vector and the environment text vector;
means to compare the plurality of words of the sense set to a plurality of navigational instructions (NIs) within a navigational corpus;
means to identify a particular NI of the plurality of NIs that corresponds to the plurality of words based on the comparison; and
means to update a vehicle trajectory of the AV based on the particular NI.

17. The system of claim 16 further comprising:
means to receive an external file comprising a rendered representation of an external environment of the AV;
means to generate an external text vector based on the external file that describes a spatio-temporal feature of the external environment of the AV in text form;
means to receive an internal file comprising a rendered representation of an internal environment of the AV;
means to generate an internal text vector based on the internal file that describes a spatio-temporal feature of the internal environment of the AV in text form;
means to receive an instruction file representative of the navigation command provided by the user in natural language; and
means to generate the instruction text vector based on the instruction file that describes the navigation command provided by the user in text form, wherein the environment text vector comprises at least one of the external text vector or the internal text vector.

18. The system of claim 16 further comprising:
means to extract a plurality of features of the external environment from the external file, wherein the external text vector is based on the plurality of features of the external environment; and
means to extract a plurality of features of the internal environment from the internal file, wherein the internal text vector is based on the plurality of features of the internal environment.

19. The system of claim 16 further comprising means to receive a user database comprising at least one of a stored address, a preferred route, or a user preference, wherein the sense set is generated further based on the user database.

20. The system of claim 16 further comprising:
means to receive the navigational corpus, the navigational corpus comprising a plurality of actions that the AV can perform;
means to determine, based on at least one of the environment text vector or the instruction text vector, a current action, a current scenario, a current NI, or a current external environment of the AV; and
means to filter the plurality of actions based on the current action, the current scenario, the current NI, or the current external environment.
